(19) United States
(12) Patent Application Publication
(10) Pub. No.: US 2014/0306855 A1
(43) Pub. Date: Oct. 16, 2014

(54) TUNABLE MULTIBAND ANTENNA

(71) Applicant: QUANTA COMPUTER INC., Tao Yuan Hsien (TW)

(72) Inventors: Chin-Lung TSAI, Chiayi City (TW); Men-Hsueh TSAI, New Taipei City (TW)

(73) Assignee: QUANTA COMPUTER INC., Tao Yuan Hsien (TW)

(21) Appl. No.: 14/102,703

(22) Filed: Dec. 11, 2013

(30) Foreign Application Priority Data
Apr. 15, 2013 (TW) 102113269

(51) Int. Cl. H01Q 5/00

(52) U.S. Cl. CPC H01Q 5/0041
USPC 343/745

(57) ABSTRACT

A tunable multiband antenna includes a first radiation conductor spaced apart from a grounding conductor, a second radiation conductor spaced apart from the grounding conductor and connected to the first radiation conductor, a first tuning unit electrically connected between a signal source and the first radiation conductor and operable to provide different impedances and a second tuning unit electrically connected between the grounding conductor and the second radiation conductor and operable to provide different impedances.

### CROSS-REFERENCE TO RELATED APPLICATION

This application claims priority of Taiwanese Application No. 102113269, filed on Apr. 15, 2013.

### BACKGROUND OF THE INVENTION

1. Field of the Invention

This invention relates to a multiband antenna, more particularly to a tunable multiband antenna.

2. Description of the Related Art

Antenna related technologies are one of the most focused fields in the fast developing wireless communication industry. One specific antenna architecture is usually only operable with one or a certain number of specific wireless communication frequency bands. Because different countries may use different wireless communication frequency bands, antenna manufacturers have to design different antennae accordingly. It has caused various issues such as higher research and development costs, delayed product launch time, numerous product versions, and higher warehousing and inventory management costs.

### SUMMARY OF THE INVENTION

Therefore, the object of the present invention is to provide a tunable multiband broadband antenna that overcomes the above drawbacks.

Accordingly, a tunable multiband antenna of the present invention is adapted to be connected to a signal source for receiving a radio frequency (RF) signal and a signal ground therefrom. The tunable multiband antenna includes of a grounding conductor, a first radiation conductor, a second radiation conductor, a first tuning unit and a second tuning unit. The grounding conductor includes a grounding terminal adapted to be connected to the signal source for receiving the signal ground therefrom. The first radiation conductor is spaced apart from the grounding conductor. The second radiation conductor is spaced apart from the grounding conductor and is coupled to the first radiation conductor. The first tuning unit is adapted to be connected between the signal source and the first radiation conductor and receives the RF signal from the signal source. The first tuning unit is operable to provide different a selected one of a plurality of different impedances. The second tuning unit is connected between the grounding conductor and the second radiation conductor. The second tuning unit is operable to provide a selected one of a plurality of different impedances.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic diagram of the first preferred embodiment of a tunable multiband antenna according to the present invention;

FIG. 2 is a voltage standing-wave ratio (VSWR) plot of the first preferred embodiment, illustrating the VSWR when a first switch is operable to connect a signal source to a first radiation conductor, and a second switch is operable to connect a grounding conductor to a second radiation conductor;

FIG. 3 is another VSWR plot of the first preferred embodiment, illustrating the VSWRs when the first switch is operated to connect the signal source to a plurality of different inductors while the second switch is operated to connect the ground conductor to the second radiation conductor;

FIG. 4 is another VSWR plot of the first preferred embodiment, illustrating the VSWRs when the second switch is operated to connect the grounding conductor to a variable capacitor with variable capacitances;

FIG. 5 is a schematic diagram of the first preferred embodiment, illustrating the configurations in size;

FIG. 6 is a radiation pattern of the first preferred embodiment at 745 Mhz under a specific setting;

FIG. 7 is a radiation pattern of the first preferred embodiment at 1730 Mhz under a specific setting;

FIG. 8 is a radiation pattern of the first preferred embodiment at 2130 Mhz under a specific setting;

FIG. 9 is a schematic diagram of the second preferred embodiment of a tunable multiband antenna according to the present invention;

FIG. 10 is a fragmentary diagram of the third preferred embodiment of a tunable multiband antenna according to the present invention;

FIG. 11 is a fragmentary diagram of the fourth preferred embodiment of a tunable multiband antenna according to the present invention;

FIG. 12 is a fragmentary diagram of the fifth preferred embodiment of a tunable multiband antenna according to the present invention;

FIG. 13 is a fragmentary diagram of the sixth preferred embodiment of a tunable multiband antenna according to the present invention;

FIG. 14 is a fragmentary diagram of the seventh preferred embodiment of a tunable multiband antenna according to the present invention; and

FIG. 15 is a fragmentary diagram of the eighth preferred embodiment of a tunable multiband antenna according to the present invention.

### DETAILED DESCRIPTION OF THE PREFERRED EMBODIMENTS

Before the present invention is described in greater detail, it should be noted that like elements are denoted by the same reference numerals throughout the disclosure.

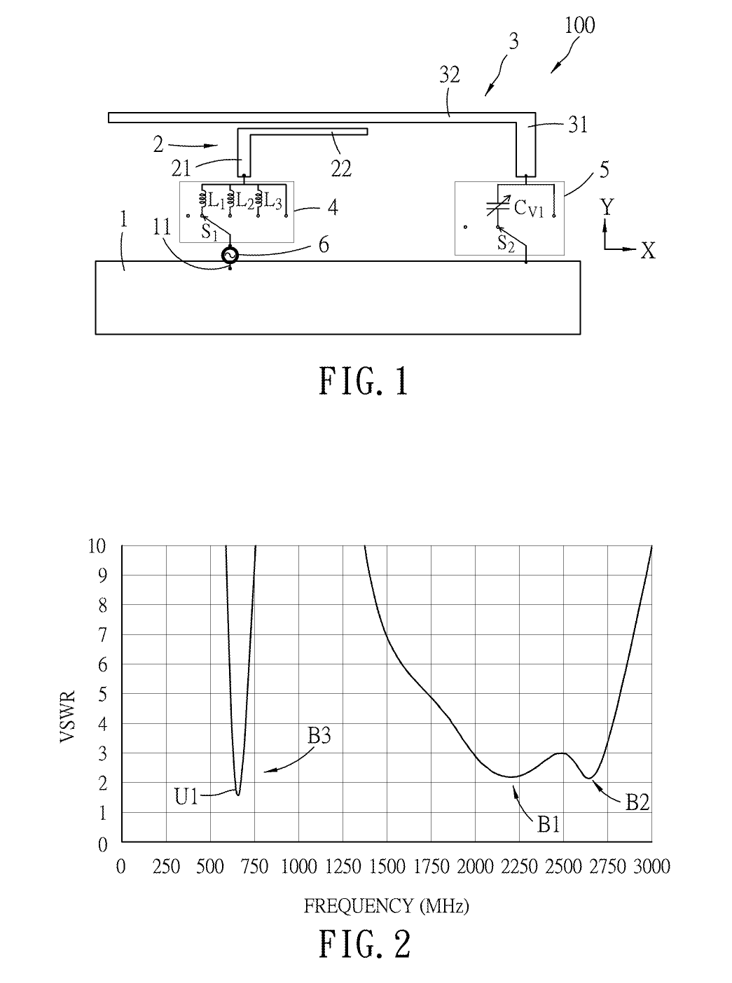

FIG. 1 shows the first preferred embodiment of a tunable multiband antenna 100 according to the present invention. The tunable multiband antenna 100 is adapted to be connected to a signal source 6 which transmits a radio frequency (RF) signal and a signal ground. In this embodiment, the signal source 6 is, but not limited to, a coaxial cable. The tunable multiband antenna 100 includes a grounding conductor 1, a first radiation conductor 2, a second radiation conductor 3, a first tuning unit 4 and a second tuning unit 5.

The grounding conductor 1 includes a grounding terminal 11 adapted to be electrically connected to the signal source 6 for receiving signal ground therefrom. The first radiation conductor 2 is spaced apart from the grounding conductor 1 has an L shape, and includes a first radiation arm 21 extending away from the grounding conductor 1 along a Y axis and a second radiation arm 22 connected to the first radiation arm 21 and extending along a X axis that is substantially perpendicular to the Y axis. The second radiation conductor 3 is spaced apart from the grounding conductor 1 has a L shape, and includes a third radiation arm 31 extending away from the grounding conductor 1 along the Y axis and a fourth radiation arm 32 connected to the third radiation arm 31 and extending alone the X axis and. The fourth radiation arm 32 extends substantially parallel to, and is spaced apart from and coupled to the second radiation arm 22.

The first tuning unit 4 is adapted to be electrically connected between the signal source 6 and the first radiation arm 21 of the first radiation conductor 2, and receives the RF signal from the signal source 6. The first tuning unit 4 is operable to provide a select one of a plurality of different impedances. In this embodiment, the first tuning unit 4 includes a plurality of inductors L₁˜L₃ having different inductances and electrically connected to the first radiation arm 21 and a first switch S₁ adapted to be connected to the signal source 6. The first switch 6 is operable to connect the signal source 6 to one of the inductors L₁˜L₃, or directly to the first radiation arm 21 of the radiation conductor 2, or to make the signal source 6 floating.

The second tuning unit 5 is electrically connected between the grounding conductor 1 and the third radiation arm 31 of the second radiation conductor 3. The second tuning unit 5 is operable to provide a selected one of a plurality of different impedances. In this embodiment, the second tuning unit 5 includes a variable capacitor C_{V1} electrically connected to the third radiation arm 31 of the second radiation conductor 3 and a second switch S₂ electrically connected to the grounding conductor 1. The second switch S₂ is operable to connect the grounding conductor 1 to the variable capacitor C_{V1} or directly to the second radiation conductor 3, or to form an open circuit between the grounding conductor 1 and the second radiation conductor 3.

FIGS. 2, 3 and 4 together with FIG. 1 explain how the resonance bands of the tunable multiband antenna 100 are tuned through the first tuning unit 4 and second tuning unit 5. When the first switch S₁ is operable to connect the signal source 6 directly to the first radiation conductor 2, and the second switch S₂ is operated to connect the grounding conductor 1 directly to the second radiation conductor 3, line U1 of FIG. 2 illustrates the voltage standing-wave ratio (VSWR) of the tunable multiband antenna 100 coupled with the signal source 6. Line U1 of FIG. 2 indicates that three modes B1, B2 and B3 can be generated cooperatively by the grounding conductor 11, the first radiation conductor 2, the second radiation conductor 3 and the signal source 6. The first radiation conductor 2 generates the first mode B1 and the second mode B2 of a higher frequency than the first mode B1. The second radiation conductor 3 generates the third mode B3 of a lower frequency than the first mode B1.

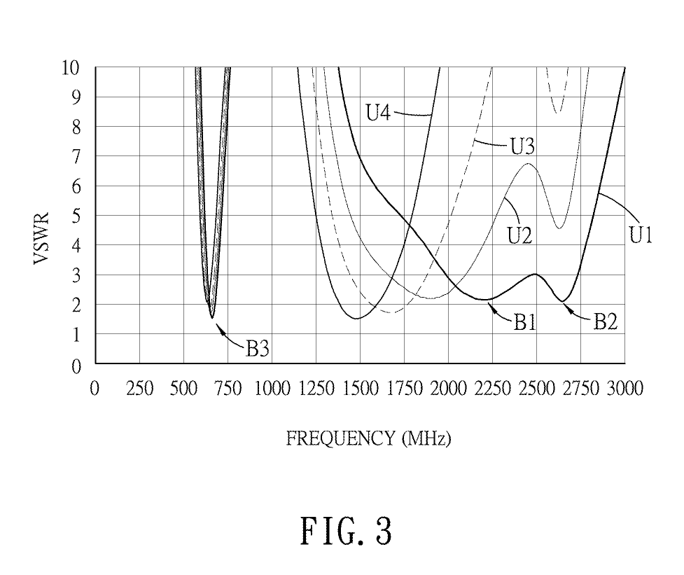

Under the condition that the second switch S₂ is operated to connect the grounding conductor 1 directly to the second radiation conductor 3, when the first switch S₁ is operated to electrically connect the signal source 6 to the inductor L₁, the VSWR of the tunable multiband antenna 100 is indicated as line U2 of FIG. 3, when the first switch S₁ is operated to connect the signal source 6 to the inductor L₂, the VSWR of the tunable multiband antenna 100 is indicated as line U3 of FIG. 3, and when the first switch S₁ is operated to connect the signal source 6 to the inductor L₃, the VSWR of the tunable multiband antenna 100 is indicated as line U4 of FIG. 3. The inductances of the inductors L₁ to L₃ are 3 nH, 6 nH and 10 nH, respectively, in this embodiment. When line U1 is compared to lines U2, U3 and U4, it is indicated that the center frequency of the first mode B1 decreases as the inductance of the first tuning unit 4 increases.

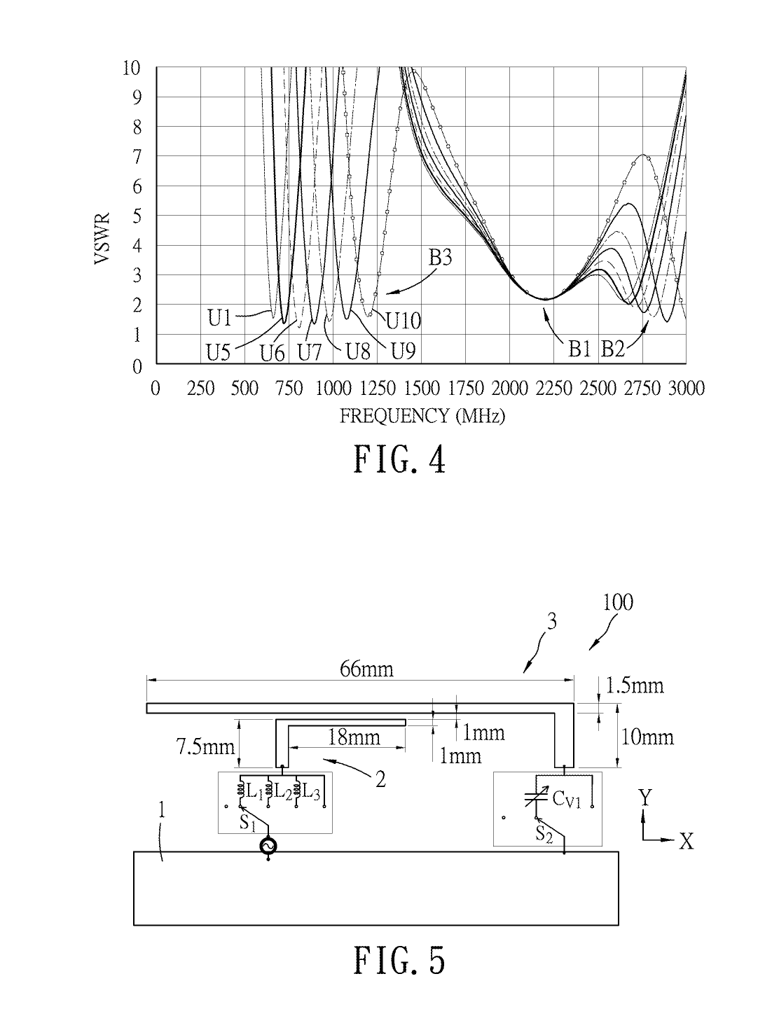

On the other hand, under the condition that the first switch S₁ is operated to connect the signal source 6 directly to the first radiation conductor 2, when the second switch S₂ is adapted to connect the grounding conductor 1 to the variable capacitor C_{V1}, varying the capacitance of the variable capacitor C_{V1} generates VSWRs as indicated in lines U5˜U10 of FIG. 4. Lines U5, U6, U7, U8, U9 and U10 are the corresponding VSWRs when the capacitance of variable capacitor C_{V1} is set at 7 pF, 2.8 pF, 1.5 pF, 0.9 pF, 0.5 pF and 0.2 pF, respectively. Comparing line U1 to line U5, U6, U7, U8, U9 and U10, it is evident that the center frequencies of the second mode B2 and the third mode B3 increase as the capacitance of the second tuning unit 5 decreases. It is apparent from FIG. 3 and FIG. 4 that the center frequencies of the first mode B1, the second mode B2 and the third mode B3 can be effectively tuned through the first tuning unit 4 and the second tuning unit 5.

FIG. 5 shows the dimensions of and the spacing between the first radiation conductor 2 and the second radiation conductor 3 of the tunable multiband antenna 100 in the first preferred embodiment.

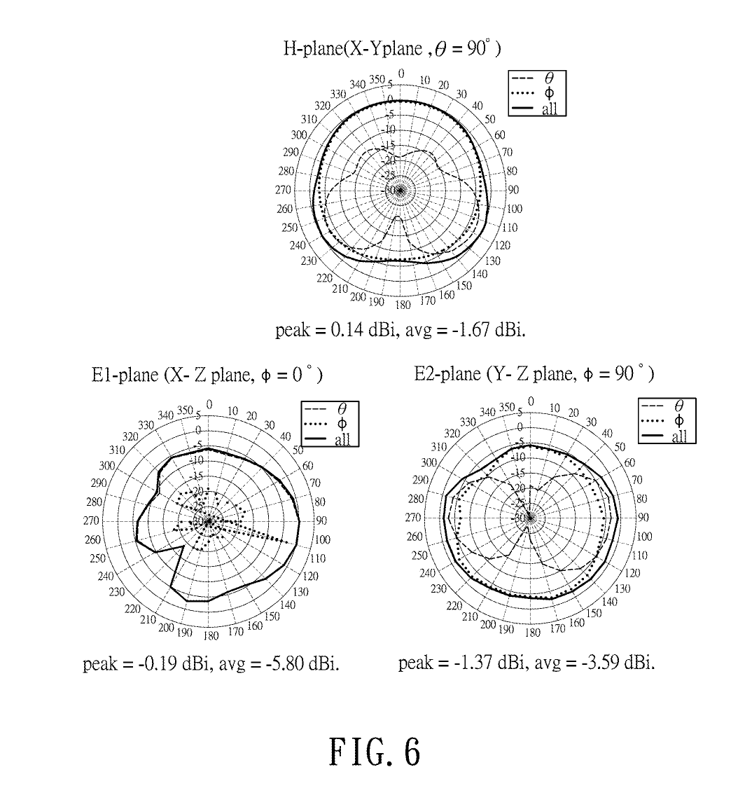

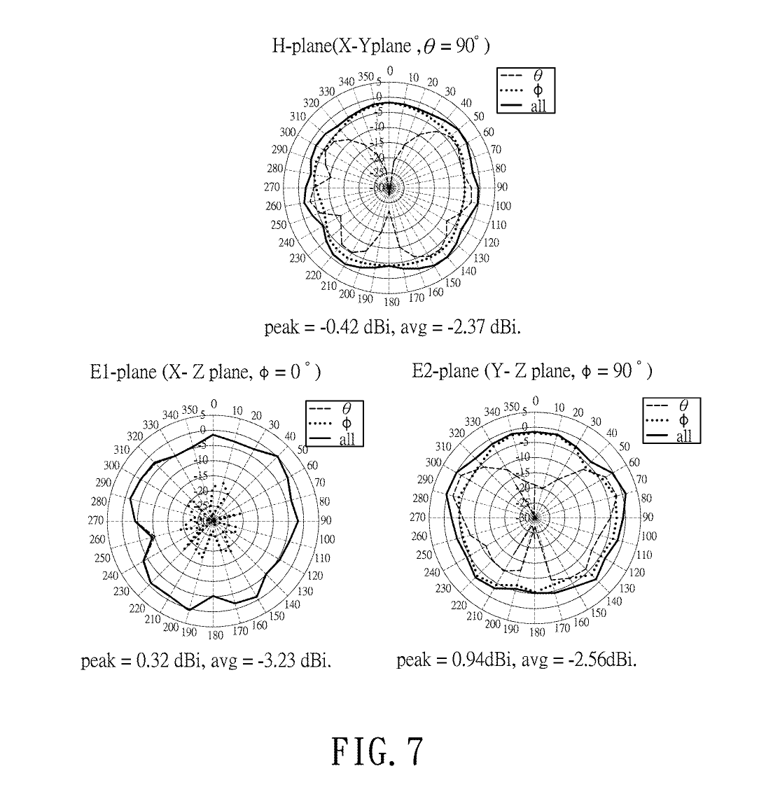

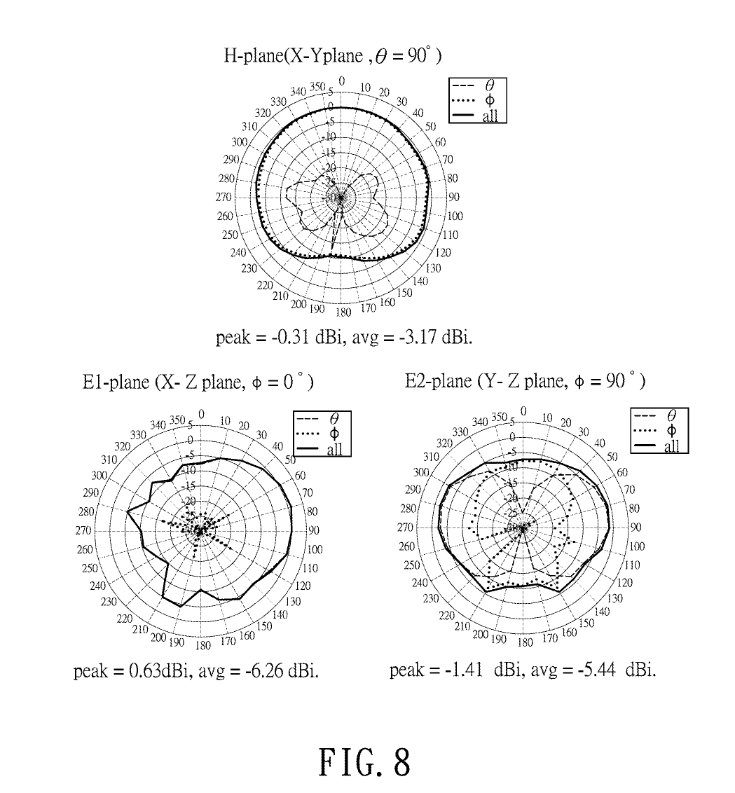

Referring to FIGS. 1, 6, 7 and 8, when the first switch S₁ is operated to connect the signal source 6 directly to the first radiation conductor 2, and the capacitance of the second tuning unit 5 is set at 7 pF, the radiation pattern of the tunable multiband antenna 100 when operating with the signal source 6 at 745 MHz is illustrated in FIG. 6. When the second switch S₂ is operated to connect the grounding conductor 1 directly to the second radiation conductor 3, and the first tuning unit 4 is tuned to have 3 nH inductance, the radiation pattern of the tunable multiband antenna 100 when operating with the signal source 6 at 1730 MHz is illustrated in FIG. 7. When the second switch S₂ is operated to connect the grounding conductor 1 directly to the second radiation conductor 3, and the first tuning unit 4 is tuned to have 10 nH inductance, the radiation pattern of the tunable multiband antenna 100 when operating with the signal source 6 at 2130 MHz is illustrated in FIG. 8.

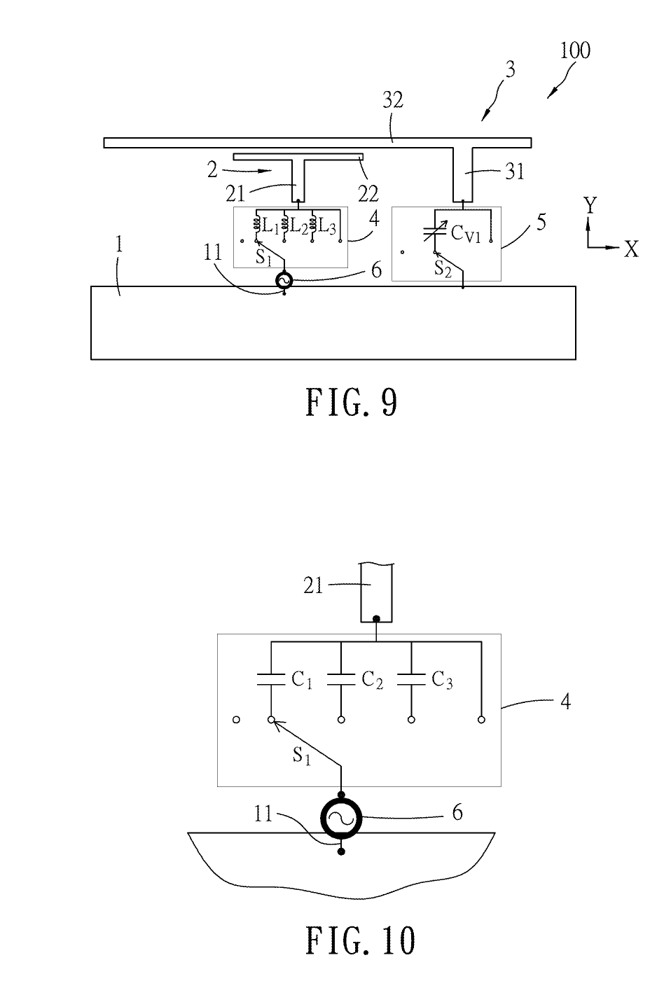

FIG. 9 illustrates the second preferred embodiment of a tunable multiband antenna 100 according to the present invention. The second preferred embodiment is similar to the first preferred embodiment, except that the first radiation arm 21 is disposed between the two ends of the second radiation arm 22 and that the third radiation arm 31 is disposed between the two ends of the fourth radiation arm 32.

Referring to FIG. 10, the third preferred embodiment of a tunable multiband antenna 100 (see FIG. 1) according to the present invention is different from the first preferred embodiment in the first tuning unit 4. The first tuning unit 4 in this embodiment includes a plurality of capacitors C1˜C3 with different capacitances that are electrically connected to the first radiation arm 21 and the first switch S₁, which is connected to the signal source 6. The first switch S₁ is operable to connect the signal source 6 to one of the capacitors C1˜C3 or directly to the first radiation arm 21, or to make the signal source 6 floating.

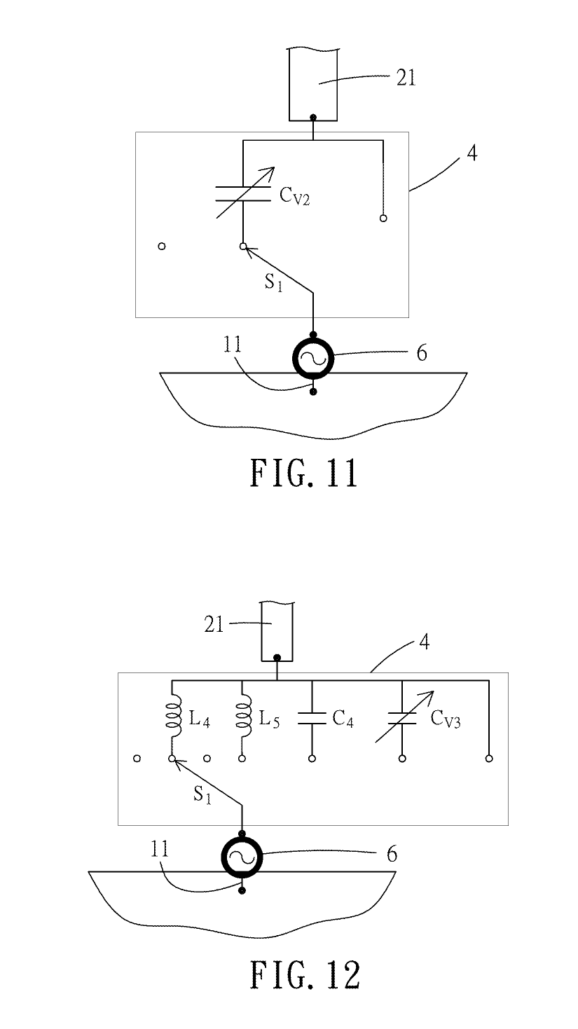

Referring to FIG. 11, the first tuning unit 4 of the fourth preferred embodiment of the tunable multiband antenna 100 (see FIG. 1) according to the present invention includes a variable capacitor C_{V2} electrically connected to the first radiation arm 21 and a first switch S₁ electrically connected to the signal source 6. The first switch S₁ is operable to connect the signal source 6 to the variable capacitor C_{V2} or directly to the first radiation arm 21, or to make the signal source 6 floating.

Referring to FIG. 12, the first tuning unit 4 of the fifth preferred embodiment of the tunable multiband antenna 100 (see FIG. 1) according to the present invention includes a variable capacitor C_{V3} electrically connected to the first radiation arm 21, two inductors L₄, L₅ and a fixed capacitor C₄, electrically connected to the first radiation arm 21 and a first switch S₁ electrically connected to the signal source 6. The first switch S₁ is operable to connect the signal source 6 to one of the variable capacitor C_{V3}, capacitor C₄, and the inductors L₄, L₅, or directly to the first radiation arm 21, or to make the signal source 6 floating.

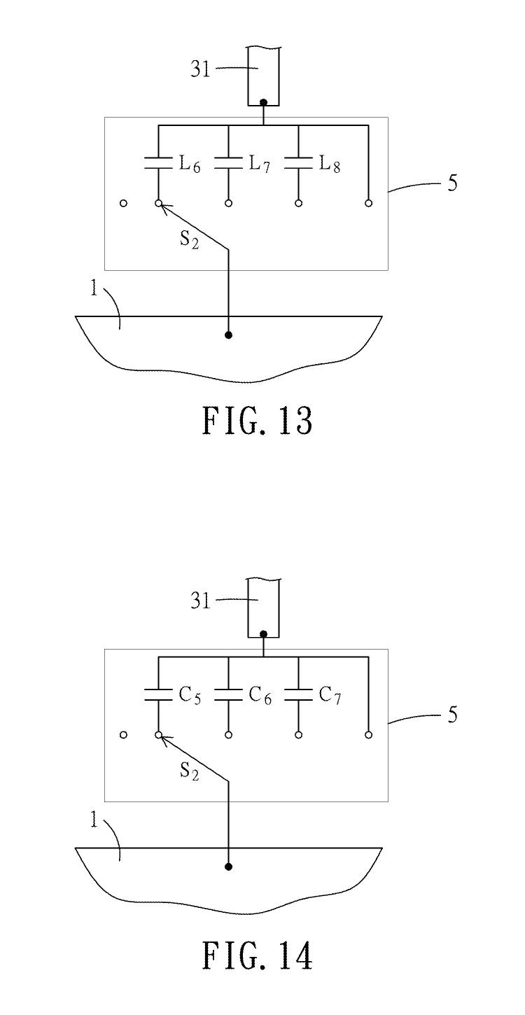

Referring to FIG. 13, the sixth preferred embodiment of a tunable multiband antenna 100 (see FIG. 1) according to the present invention is different to the first preferred embodiment in the second tuning unit. In this embodiment, the second tuning unit 5 includes a plurality of inductors L₆˜L₈ having different inductances and electrically connected to the third radiation arm 31, and a second switch S₂ electrically connected to the grounding conductor 1. The second switch S₂ is operable to connect the grounding conductor 1 to one of the inductors L₆˜L₈, or directly to the third radiation arm 31, or to form an open circuit between the grounding conductor 1 and the third radiation arm 31.

Referring to FIG. 14, the seventh preferred embodiment of a tunable multiband antenna 100 (see FIG. 1) according to the present invention is different from the first preferred embodiment in the second tuning unit 5. In this embodiment, the second tuning unit 5 includes a plurality of capacitors C₅˜C₇ having different capacitances and electronically connected to the third radiation arm 31, and a second switch S₂ electronically connected to the grounding conductor 1. The second switch S₂ is operable to connect the grounding conductor 1 to one of the capacitors C₅˜C₇, or directly to the third radiation arm 31, or to form an open circuit between the grounding conductor 1 and the third radiation arm 31.

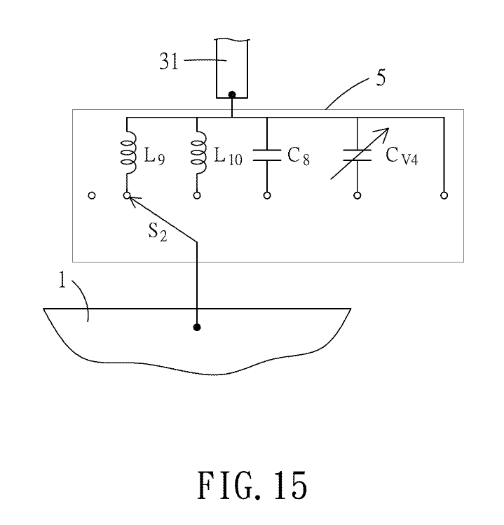

Referring to FIG. 15, the eighth preferred embodiment of the tunable multiband antenna 100 (see FIG. 1) according to the present invention is different from the first preferred embodiment in the second tuning unit 5. In this embodiment, the second tuning unit 5 includes a variable capacitor C_{V4}, a fixed capacitor C₈ and two inductors L₉, L₁₀ electrically connected to the third radiation arm 31, and a second switch S₂ electrically connected to the grounding conductor 1. The second switch S₂ is operable to connect the grounding conductor 1 to one of the variable capacitor C_{V4}, the fixed capacitor C₈, the inductors L₉, L₁₀ or directly to the third radiation arm 31, or to form an open circuit between the grounding conductor 1 and the third radiation arm 31.

Concluding the above disclosure, the tunable multiband antenna 100 according to the present invention offers tunable resonance frequency bands by adjusting the impedances between the grounding conductor 1 and the first and second radiation conductors 2, 3 through operations of the first tuning unit 4 and second tuning unit 5. Therefore, the tunable multiband antenna 100 can be used in different countries with different wireless communication frequency bands to achieve lower research and development costs, shorter product launch time, fewer product versions, and lower warehousing and inventory management costs.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A tunable multiband antenna adapted to be connected to a signal source for receiving a radio frequency (RF) signal and a signal ground therefrom, the tunable multiband antenna comprising:
a grounding conductor including a grounding terminal adapted to be connected to the signal source for receiving the signal ground therefrom;
a first radiation conductor spaced apart from said grounding conductor;
a second radiation conductor spaced apart from said grounding conductor and coupled to said first radiation conductor;
a first tuning unit adapted to be connected between the signal source and said first radiation conductor and receiving the radio frequency signal from the signal source, said first tuning unit being operable to provide a selected one of a plurality of different impedances; and
a second tuning unit connected between said grounding conductor and said second radiation conductor, and operable to provide a selected one of a plurality of different impedances.

2. The tunable multiband antenna of claim 1, wherein said first tuning unit includes:
a plurality of inductors having different inductances and connected to said first radiation conductor; and
a first switch adapted to be connected to the signal source, and operable to connect the signal source to one of said inductors.

3. The tunable multiband antenna of claim 2, wherein said first switch is further operable to make the signal source floating or to connect the signal source directly to said first radiation conductor.

4. The tunable multiband antenna of claim 1, wherein said first tuning unit includes:
a plurality of capacitors having different capacitances and connected to said first radiation conductor; and
a first switch adapted to be connected to the signal source, and operable to connect the signal source to one of said capacitors.

5. The tunable multiband antenna of claim 4, wherein said first switch is further operable to make the signal source floating or to connect the signal source directly to said first radiation conductor.

6. The tunable multiband antenna of claim 1, wherein said first tuning unit includes:
a variable capacitor connected to said first radiation conductor; and
a first switch adapted to be connected to the signal source, and operable to connect the signal source to said variable capacitor or directly to said first radiation conductor, or to make the signal source floating.

7. The tunable multiband antenna of claim 1, wherein said first tuning unit includes:
a variable capacitor connected to said first radiation conductor;
a fixed capacitor connected to said first radiation conductor;
an inductor connected to said first radiation conductor; and
a first switch adapted to be connected to the signal source, and operable to connect the signal source to one of said variable capacitor, said fixed capacitor and said inductor, or directly to said first radiation conductor, or to make the signal source floating.

8. The tunable multiband antenna of claim 1, wherein said second tuning unit includes:
a plurality of inductors having different inductances and connected to said second radiation conductor; and
a second switch connected to said grounding conductor and operable to connect said grounding conductor to one of said inductors.

9. The tunable multiband antenna of claim 8, wherein said second switch is further operable to connect said grounding conductor directly to said second radiation conductor, or to form an open circuit between said grounding conductor and said second radiation conductor.

10. The tunable multiband antenna of claim 1, wherein said second tuning unit includes:
a plurality of capacitors having different capacitances and connected to said second radiation conductor; and
a second switch connected to said grounding conductor and operable to connect said grounding conductor to one of said capacitors.

11. The tunable multiband antenna of claim 10, wherein said second switch is further operable to connect said grounding conductor directly to said second radiation conductor, or to form an open circuit between said grounding conductor and said second radiation conductor.

12. The tunable multiband antenna of claim 1, wherein said second tuning unit includes:
a variable capacitor connected to said second radiation conductor; and
a second switch connected to said grounding conductor, and operable to connect said grounding conductor to said variable capacitor or directly to said second radiation conductor, or to form an open circuit between said grounding conductor and said second radiation conductor.

13. The tunable multiband antenna of claim 1, wherein said second tuning unit includes:
a variable capacitor connected to said second radiation conductor;
a fixed capacitor connected to said second radiation conductor;
an inductor connected to said second radiation conductor; and
a second switch connected to said grounding conductor, and operable to connect said grounding conductor to said variable capacitor, said fixed capacitor, said inductor or directly to second radiation conductor, or to form an open circuit between said grounding conductor and said second radiation conductor.

14. The tunable multiband antenna of claim 1, wherein said first radiation conductor generates a first mode and a second mode of higher frequency than the first mode, and said second radiation conductor generates a third mode of lower frequency than the first mode;
a central frequency of the first mode being different when said first tuning unit provides the different impedances, a central frequency of each of the second and third modes being different when said second tuning unit provides the different impedances.

15. The tunable multiband antenna of claim 1, wherein said first radiation conductor includes
a first radiation arm connected to said first tuning unit, and a second radiation arm connected substantially perpendicularly to said first radiation arm, and said second radiation conductor includes a third radiation arm connected to said second tuning unit, and a fourth radiation arm connected substantially perpendicularly to said third radiation arm and extending substantially parallel to, and being spaced apart from and coupled to said second radiation arm of said first radiation conductor.
